(19) United States
(12) Patent Application Publication
(10) Pub. No.: US 2017/0219066 A1
(43) Pub. Date: Aug. 3, 2017

(54) BICYCLE DRIVING DEVICE

(71) Applicant: Shimano Inc., Osaka (JP)

(72) Inventor: Takashi YAMAMOTO, Osaka (JP)

(21) Appl. No.: 15/391,775

(22) Filed: Dec. 27, 2016

(30) Foreign Application Priority Data
Jan. 29, 2016 (JP) 2016-016434

(51) Int. Cl. F16H 3/72; B62M 6/90; F16H 37/06; B62M 6/50; B62M 11/14; B62M 6/55; B62M 11/18

(52) U.S. Cl. CPC F16H 3/728; B62M 6/55; B62M 6/90; B62M 11/18; B62M 6/50; B62M 11/145; F16H 37/065; B60Y 2200/13; B60Y 2200/91

(57) ABSTRACT

A bicycle driving device that allows a second motor to be reduced in size includes a first planetary mechanism, a first motor, a second motor, and a speed reduction mechanism. The first planetary mechanism includes a first input body to which rotation of a crank is input, a first output body that rotates when the first input body rotates, and a first transmission body that transmits rotation of the first input body to the first output body. The first motor is capable of rotating at least one of the first input body, the first output body, and the crank. The speed reduction mechanism reduces rotation produced by the second motor in speed and transmits the rotation to the first transmission body.

### CROSS-REFERENCE TO RELATED APPLICATIONS

This application claims priority to Japanese Patent Application No. 2016-016434, filed on Jan. 29, 2016 The entire disclosure of Japanese Patent Application No. 2016-016434 is hereby incorporated herein by reference.

### BACKGROUND

Field of the Invention

The present disclosure generally relates to a bicycle driving device.

Background Information

U.S. Patent Application Publication No. 2012/0010036 describes a bicycle driving device that includes a first motor, a second motor and a planetary mechanism. The planetary mechanism includes an input body that receives human power inputted to a crank, an output body that rotates when the input body rotates and a transmission body that transmits rotation of the input body to the output body. The first motor transmits torque to the output body of the planetary mechanism and the second motor transmits torque to the transmission body of the planetary mechanism.

When the crank and the first motor are driven to rotate the output body, a reaction force acts on a rotational shaft of the second motor in a direction opposite to the rotational direction. Since the second motor needs to produce rotation that counters the reaction force, it is difficult to reduce the size of the second motor.

### SUMMARY

One object of the subject matter of the present disclosure to provide a bicycle driving device that allows the second motor to be reduced in size.

A first aspect of the subject matter of the present disclosure is a bicycle driving device including a first planetary mechanism, a first motor, a second motor and a speed reduction mechanism. The first planetary mechanism includes a first input body to which rotation of a crank is inputted, a first output body that rotates when the first input body rotates, and a first transmission body that transmits rotation of the first input body to the first output body. The first motor is configured to rotate at least one of the first input body, the first output body and the crank. The speed reduction mechanism is configured to reduce rotation produced by the second motor in speed and transmits the rotation to the first transmission body.

In a second aspect of the bicycle driving device according to the first aspect, the speed reduction mechanism includes a second planetary mechanism including a second input body to which rotation produced by the second motor is input, a second output body that rotates when the second input body rotates, and a second transmission body that transmits rotation of the second input body to the second output body.

In a third aspect of the bicycle driving device according to any one of the preceding aspects, the second input body includes a second sun gear, the second output body includes a second planetary gear and a second carrier, and the second transmission body includes a second ring gear.

A fourth aspect of the bicycle driving device according to any one of the preceding aspects further includes a housing non-rotatably supporting the second ring gear.

In a fifth aspect of the bicycle driving device according to any one of the preceding aspects, the first input body includes a first ring gear, the first output body includes a first planetary gear and a first carrier, the first transmission body includes a first sun gear, the first planetary gear includes a first gear portion that engages the first ring gear and a second gear portion that engages the first sun gear, and the first gear portion differs from the second gear portion in the number of teeth.

In a sixth aspect of the bicycle driving device according to any one of the preceding aspects, the first output body includes a first ring gear, the first input body includes a first planetary gear and a first carrier, the first transmission body includes a first sun gear, the first planetary gear includes a first gear portion that engages the first ring gear and a second gear portion that engages the first sun gear, and the first gear portion differs from the second gear portion in the number of teeth.

In a seventh aspect of the bicycle driving device according to any one of the preceding aspects, the first gear portion has fewer teeth than the second gear portion.

In an eighth aspect of the bicycle driving device according to any one of the preceding aspects, the first input body includes a first ring gear, the first output body includes a first planetary gear and a first carrier, the first transmission body includes a first sun gear, and the first input body and the second transmission body rotate integrally with each other.

In a ninth aspect of the bicycle driving device according to any one of the preceding aspects, the first input body includes a first planetary gear and a first carrier, the first output body includes a first ring gear, the first transmission body includes a first sun gear, and the first output body and the second transmission body rotate integrally with each other.

In a tenth aspect of the bicycle driving device according to any one of the preceding aspects, the first sun gear has the same number of teeth as the second sun gear.

In an eleventh aspect of the bicycle driving device according to any one of the preceding aspects, the first ring gear has the same number of teeth as the second ring gear.

In a twelfth aspect of the bicycle driving device according to any one of the preceding aspects, the second planetary mechanism is coaxial with the first planetary mechanism.

In a thirteenth aspect of the bicycle driving device according to any one of the preceding aspects, the crank includes a crankshaft, and the first planetary mechanism is coaxial with the crankshaft and located at an outer side in a radial direction of the crankshaft.

In a fourteenth aspect of the bicycle driving device according to any one of the preceding aspects, the crank includes a crankshaft, and the crankshaft includes a portion located at an outer side in a radial direction of the first planetary mechanism from an outer circumferential portion of the first planetary mechanism.

In a fifteenth aspect of the bicycle driving device according to any one of the preceding aspects, the first planetary mechanism has an axis that is parallel to an axis of the crankshaft, the first motor includes an output shaft having an axis that is parallel to the axis of the crankshaft, and the first motor is located next to the crankshaft at a position separated from the first planetary mechanism in a circumferential direction of the crankshaft.

In a sixteenth aspect of the bicycle driving device according to any one of the preceding aspects, the second motor includes an output shaft that is coaxial with the first input body.

The bicycle driving device of the present disclosure enables control to be executed in accordance with the cycling conditions and the like.

### BRIEF DESCRIPTION OF THE DRAWINGS

FIG. 1 is a side elevational view of a drivetrain of a motor assisted bicycle hat is equipped with a bicycle driving device in accordance with a first embodiment.

FIG. 2 is a cross-sectional view of the bicycle driving device shown in FIG. 1.

FIG. 3 is a cross-sectional view of a bicycle driving device in accordance with a second embodiment.

FIG. 4 is a cross-sectional view of a bicycle driving device in accordance with a third embodiment.

FIG. 5 is a cross-sectional view of a bicycle driving device in accordance with a fourth embodiment.

FIG. 6 is a cross-sectional view of a bicycle driving device in accordance with a fifth embodiment.

FIG. 7 is a schematic diagram of a switching mechanism shown in FIG. 6 when a crankshaft is rotated in a first direction.

FIG. 8 is a schematic diagram of the switching mechanism shown in FIG. 6 when the crankshaft is rotated in a second direction.

FIG. 9 is a cross-sectional view showing the bicycle driving device of the third embodiment.

### DESCRIPTION OF THE EMBODIMENTS

Selected embodiments of a bicycle drive unit will now be explained with reference to the drawings. It will be apparent to those skilled in the bicycle field from this disclosure that the following descriptions of the embodiments are provided for illustration only and not for the purpose of limiting the invention as defined by the appended claims and their equivalents.

### First Embodiment

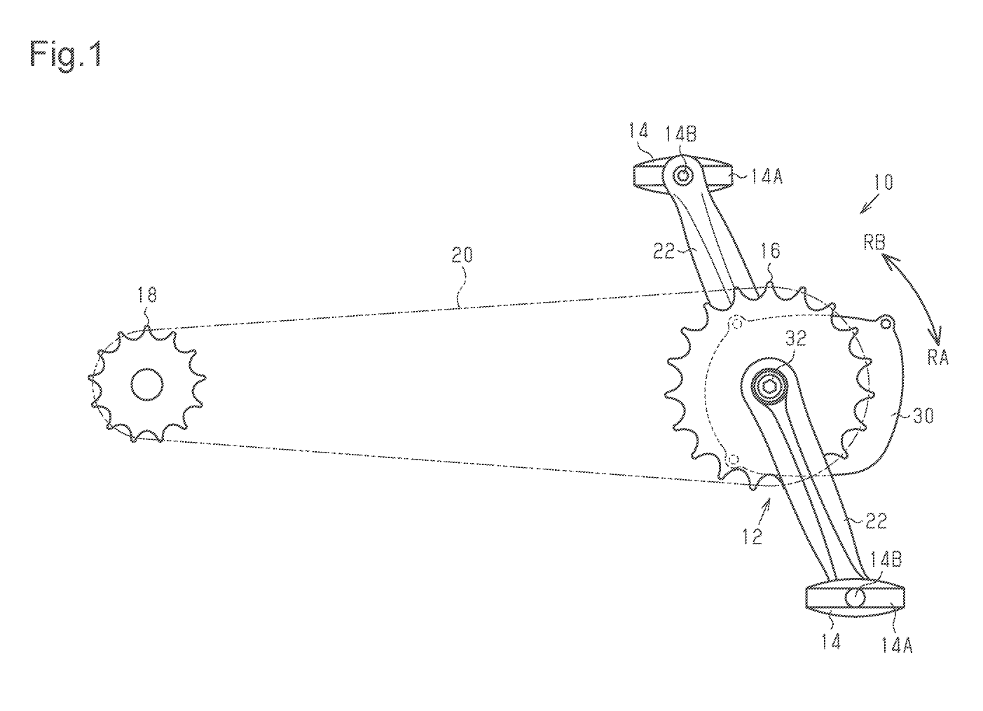

Referring initially to FIG. 1, a side elevational view of a motor assisted bicycle (i.e., a pedelec) 10 is illustrated that is equipped with a bicycle driving device 30 in accordance with a first embodiment. The motor assisted bicycle 10 will hereafter be referred to as “the bicycle 10”.) In one example, the bicycle 10 includes a crank 12, two pedals 14, a front sprocket 16, a rear sprocket 18 and a chain 20. The crank 12 includes two crank arms 22 and a crankshaft 32.

The two crank arms 22 are respectively coupled to the two ends of the crankshaft 32 so as to rotate integrally with the crankshaft 32. Each of the pedals 14 includes a pedal body 14A and a pedal shaft 14B. The pedal shaft 14B is coupled to the corresponding one of the crank arms 22 so as to rotate integrally with the corresponding one of the crank arms 22. The pedal body 14A is supported by the pedal shaft 14B so as to be rotatable relative to the pedal shaft 14B.

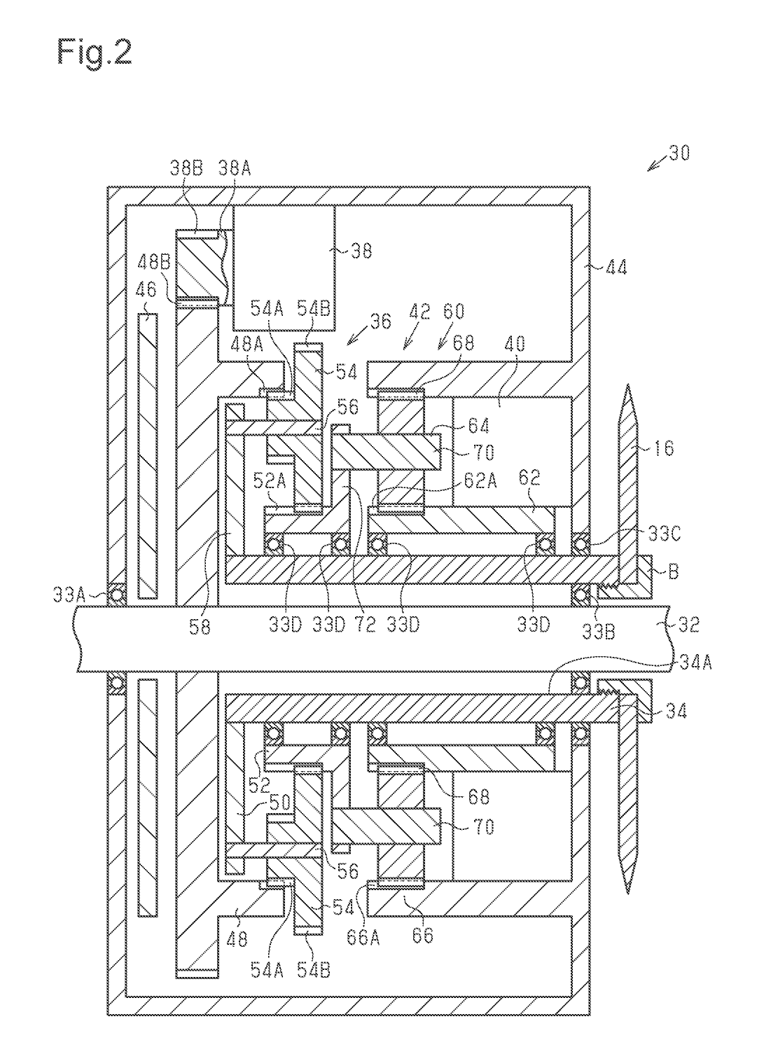

The front sprocket 16 is coupled to an output part 34 of the bicycle driving device 30 (refer to FIG. 2). The rear sprocket 18 is coupled to a drive wheel (not shown). The chain 20 runs around the front sprocket 16 and the rear sprocket 18. In one example, the drive wheel is a rear wheel. The hub of the drive wheel, which is coupled to the rear sprocket 18, can be configured to include a coaster brake.

As shown in FIG. 2, in addition to the output part 34, the bicycle driving device 30 further includes a first planetary mechanism 36, a first motor 38, a second motor 40 and a speed reduction mechanism 42. In one example, in addition to the crankshaft 32, the bicycle driving device 30 further includes a housing 44 and a controller 46. The bicycle driving device 30 assists human power that is input to the crank 12. The crankshaft 32 is supported by the housing 44 so as to be rotatable relative to the housing 44. The crankshaft 32 includes one axial end supported by the housing 44 with a bearing 33A and another axial end supported by the output part 34 with a bearing 33B. The crankshaft 32 is rotatable relative to the housing 44 in a forward rotation direction in which the bicycle 10 moves forward (hereafter referred to as “the first direction RA”) and a direction opposite to the forward rotation direction (hereafter referred to as “the second direction RB”). The crankshaft 32 can be solid or hollow.

The first planetary mechanism 36, the first motor 38, the second motor 40, the output part 34, the crankshaft 32, the speed reduction mechanism 42 and the controller 46 are arranged in the housing 44. It is preferred that the controller 46 be arranged in the housing 44. However, the controller 46 can be arranged outside the housing 44, for example, on the frame of the bicycle 10.

The two ends of the crankshaft 32 project out of the housing 44. Rotational input from the pedals 14 (refer to FIG. 1) to the crankshaft 32 is transmitted to a first input body 48 of the first planetary mechanism 36 shown in FIG. 2.

The output part 34 is tubular and includes a bore 34A. The crankshaft 32 extends through the bore 34A. The output part 34 is rotatable about the axis of the crankshaft 32. Rotation of a first output body 50 of the first planetary mechanism 36 is transmitted to the output part 34. One end of the output part 34 projects out of the housing 44. The output part 34 is rotationally supported by the housing 44 with a bearing 33C. The portion of the output part 34 projecting from the housing 44 is coupled by a bolt B to the front sprocket 16. The bolt B is fastened to the bore 34A of the output part 34 to fix the output part 34 to the front sprocket 16. Splines can be formed in the outer circumferential portion of the output part 34. For example, the front sprocket 16 can be engaged with the splines to restrict rotation of the front sprocket 16 relative to the crankshaft 32. Further, a step can be formed in the outer circumferential portion of the crankshaft 32 to cooperate with the bolt B and restrict axial movement of the front sprocket 16. The front sprocket 16 and the bolt B can be coupled to the outer circumferential portion of the output part 34. The front sprocket 16 can be a pulley.

The first planetary mechanism 36 is a planetary gear mechanism. The first planetary mechanism 36 includes the first input body 48, a first transmission body 52 and the first output body 50. The first planetary mechanism 36 is coaxial with the crankshaft 32 and located at the outer side of the crankshaft 32 in the radial direction.

Referring to FIG. 2, the rotation of the crankshaft 32 is input to the first input body 48. The first input body 48 is an annular body. Further, the first input body 48 is coaxial with the crankshaft 32 and fixed to the crankshaft 32. The first input body 48 includes a first ring gear 48A and a first motor gear 48B. The first ring gear 48A is formed on the inner circumferential portion of the first input body 48. The first motor gear 48B is formed in the outer circumferential portion of the first input body 48. The first input body 48 is spline-fitted or press-fitted to the outer circumferential portion of the crankshaft 32. Thus, the first input body 48 is rotated integrally with the crankshaft 32.

The first transmission body 52 transmits the rotation of the first input body 48 to the first output body 50. The first transmission body 52 includes a first sun gear 52A. The first transmission body 52 is an annular body. The first transmission body 52 is rotationally supported by the output part 34 with a bearing.

The first output body 50 rotates when the first input body 48 rotates. The first output body 50 includes a plurality of first planetary gears 54, a plurality of first planetary pins 56 and a first carrier 58. The first planetary gears 54 are located between the first sun gear 52A and the first ring gear 48A. Each of the first planetary gears 54 includes a first gear portion 54A and a second gear portion 54B. The first gear portion 54A differs from the second gear portion 54B in the number of teeth. The first gear portion 54A has fewer teeth than the second gear portion 54B. The first planetary gears 54 are each a stepped planetary gear. The teeth of the first gear portion 54A engage the teeth of the first ring gear 48A. The teeth of the second gear portion 54B engage the teeth of the first sun gear 52A.

Each of the first planetary pins 56 extends through the corresponding one of the first planetary gears 54 in the axial direction. The first planetary pins 56 are moved integrally with the first carrier 58. Each of the first planetary gears 54 is supported by the corresponding one of the first planetary pins 56 in a manner rotatable relative to the first planetary pins 56. The first planetary pins 56 are supported by the first carrier 58. The first planetary gears 54 and the corresponding one of the first planetary pins 56 are coaxial. The first planetary pins 56 can be rotationally supported by the first carrier 58 and fixed to the corresponding one of the first planetary gears 54. The first carrier 58 is an annular member.

Rotation of the first carrier 58 is output to the output part 34. The inner circumferential portion of the first carrier 58 is spline-fitted or press-fitted to the outer circumferential portion of the output part 34. Thus, the first output body 50 rotates integrally with the output part 34.

The first motor 38 is supported by the housing 44. The first motor 38 is located at the outer side of the crankshaft 32 in the radial direction of the crankshaft 32. The first motor 38 is capable of rotating the first input body 48. The first motor 38 has a first output shaft 38A including a gear 38B that is engaged with the first motor gear 48B of the first input body 48. The gear 38B has fewer teeth than the first motor gear 48B. Thus, the rotation produced by the first motor 38 is reduced in speed and increased in torque when transmitted to the first input body 48.

The second motor 40 is supported by the housing 44. The second motor 40 includes an output shaft, which is coaxial with the first input body 48. The second motor 40 is capable of rotating the first transmission body 52 with the speed reduction mechanism 42.

The speed reduction mechanism 42 reduces the speed of the rotation produced by the second motor 40 and transmits the rotation to the first transmission body 52. The speed reduction mechanism 42 includes a second planetary mechanism 60. The second planetary mechanism 60 is a planetary gear mechanism. The second planetary mechanism 60 includes a second input body 62, a second output body 64 and a second transmission body 66. The axis of the second planetary mechanism 60 coincides with the axis of the crankshaft 32. The second planetary mechanism 60 and the first planetary mechanism 36 are coaxial.

The rotation of the second motor 40 is input to the second input body 62, which is an annular body. The second input body 62 is rotationally supported by the output part 34 with a bearing. The second input body 62 includes a second sun gear 62A. The second sun gear 62A is formed integrally with the output shaft of the second motor 40. In another example, the second sun gear 62A is separate from the output shaft of the second motor 40 and coupled to the output shaft of the second motor 40. The first sun gear 52A has the same number of teeth as the second sun gear 62A. The number of teeth of the first sun gear 52A can differ from the number of teeth of the second sun gear 62A. The output shaft of the second motor 40 is an annular member.

The second transmission body 66 transmits the rotation of the second input body 62 to the second output body 64. The second transmission body 66 includes a second ring gear 66A. The second ring gear 66A is supported by the housing 44 in a non-rotatable manner. The second transmission body 66 can be formed integrally with the housing 44. Alternatively, the second transmission body 66 can be formed separately from the housing and be coupled to the housing 44. The first ring gear 48A has the same number of teeth as the second ring gear 66A. The number of teeth of the first ring gear 48A can differ from the number of teeth of the second ring gear 66A.

The second output body 64 rotates when the second input body 62 rotates. The second output body 64 includes a plurality of second planetary gears 68, a plurality of second planetary pins 70 and a second carrier 72. Each of the second planetary gears 68 is located between the second sun gear 62A and the second ring gear 66A and engages the second sun gear 62A and second ring gear 66A.

Each of the second planetary pins 70 extends through the corresponding one of the second planetary gears 68 in the axial direction. The second planetary pins 70 are movable integrally with the second carrier 72. Each of the second planetary gears 68 is supported by the corresponding one the second planetary pins 70 in a manner rotatable relative to the second planetary pins 70. The second planetary pins 70 are supported by the second carrier 72. The second planetary gears 68 and the corresponding ones of the second planetary pins 70 are coaxial. The second planetary pins 70 can be rotationally supported by the second carrier 72 and fixed to the corresponding one of the second planetary gears 68. The second carrier 72 is an annular member.

Rotation of the second carrier 72 is output to the first transmission body 52. The second carrier 72 is formed integrally with the first transmission body 52. In another example, the second carrier 72 is formed separately from the first transmission body 52 and coupled to the outer circumferential portion of the first transmission body 52 in a non-rotatable manner. The second carrier 72 rotates integrally with the first transmission body 52. The second carrier 72 and the second input body 62 are rotationally supported by the output part 34 with bearings 33D.

The controller 46 includes a central processing unit (CPU) and a memory. The controller 46 further includes a circuit board on which the CPU and the memory are mounted. In one example, the memory includes a non-volatile memory and stores control programs executed by the CPU and various types of setting information. The controller 46 is electrically connected to the first motor 38 and the second motor 40. The controller 46 receives signals from various types of sensors. It is preferred that the sensors include a vehicle speed sensor that detects the vehicle speed. The controller 46 and the motors 38 and 40 are supplied with power from a battery (not shown) that is arranged on the bicycle 10.

The controller 46 is programmed to control the first motor 38 and the second motor 40. More specifically, the controller 46 controls the rotation produced by the first motor 38 and the rotation produced by the second motor 40 in accordance with at least one of the human power, the rotational speed of the crankshaft 32 and the vehicle speed. The controller 46 is programmed to control the output torque of the first motor 38 in accordance with the human power based on an assist ratio that is preset in advance. The human power is calculated from, for example, the torque of the second motor 40. The torque of the second motor 40 can be detected to estimate the human power. The controller 46 can control the first motor 38 and the second motor 40 in any one of a first mode, a second mode, a third mode and a fourth mode. The controller 46 is programmed to drive only the first motor 38 in the first mode. The controller 54 is further programmed to drive both of the first motor 38 and the second motor 40 in the second mode. The controller 54 is further programmed to drive only the second motor 40 in the third mode. The controller 54 is further programmed to not drive any of the first motor 38 and the second motor 40 in the fourth mode. An operation unit can be used to select each mode. The torque of the second motor 40 is proportional to the torque of the first input body 48. Thus, the controller 46 can detect the torque of the second motor 40 to obtain the human power. Even when the torque of the first input body 48 is generated by the first motor 38 and the human power, the controller 46 controls the torque of the first motor 38. This allows for only the human power to be obtained. The torque of the second motor 40 can be obtained by detecting the current of the second motor 40. Alternatively, the torque of the second motor 40 can be obtained from the current applied to the second motor 40 or control parameters of the controller 46 for the second motor 40. The rotational speed of the crankshaft 32 is calculated from, for example, the rotational speed of the first motor 38. The controller 46 can calculate the rotational speed of the crankshaft 32 from the rotational speed of the first motor 38. The controller 46 determines the rotational speed of the first motor 38 from the current of the first motor 38 or the detection signal of an encoder provided for the first motor 38.

The sensors can include a torque sensor that detects the human power or a rotational speed sensor that detects the rotational speed of the crankshaft 32. The torque sensor is, for example, a strain gauge, a semiconductor strain gauge, or a magnetostrictive sensor. The torque sensor is coupled to the crankshaft 32 or the first input body 48 to detect the torque applied to the crankshaft 32. In another example, the torque sensor is coupled to the output part 34 to detect the torque applied to the output part 34. The rotational speed sensor is arranged in the housing 44 and includes a magnetic sensor that detects a magnet arranged on the crankshaft 32. The vehicle speed is calculated from, for example, the output of the vehicle speed sensor. It is preferred that the supply of power to the first motor 38 and the second motor 40 be stopped when the rotation of the crankshaft 32 is stopped and when the crankshaft 32 is rotated in the second direction RB. The controller 46 can control the rotation of the second motor 40 in accordance with an instruction from a gear change instruction device that is operable by the rider.

The controller 46 produces rotation with the first motor 38 to rotate the first input body 48 in the forward direction. When the first input body 48 is rotated in the forward rotation direction, rotation is transmitted to the output part 34 in the direction that the bicycle 10 moves forward. In the present embodiment, the forward rotation direction is the same direction as the first direction RA of the crankshaft 32.

The controller 46 produces rotation with the second motor 40 to rotate the first transmission body 52 in the forward rotation direction. As the torque in the forward rotation direction transmitted to the first transmission body 52 from the second motor 40 increases, the gear ratio r of the planetary mechanism 36 increases. Here, the gear ratio for reducing speed is defined as a negative gear ratio, and the gear ratio decreases as the speed reduction ratio increases. The controller 46 can control the rotational speed of the second motor 40 to continuously vary the gear ratio r. The gear ratio r of the planetary mechanism 36 is the ratio of the speed of the rotation output from the first output body 50 relative to the speed of the rotation input to the first input body 48. Although the speed of the planetary mechanism 36 is continuously variable, it is preferred that the controller 46 control the rotation produced by the second motor 40 to obtain any one of predetermined gear ratios. The speed reduction ratio of the speed reduction mechanism 42 is selected so that the torque applied to the output shaft of the second motor 40 from the crankshaft 32 and the first motor 38 is 5% or less, preferably 2% or less, and further preferably 1% or less of the total torque of the crankshaft 32 and the first motor 38.

The operation of the bicycle driving device 30 will now be described.

The bicycle driving device 30 includes the speed reduction mechanism 42 that reduces the speed of the rotation produced by the second motor 40 and transmits the rotation to the first transmission body 52. This allows for reduction in the torque applied to the output shaft of the second motor 40 from the crankshaft 32 and the first motor 38. Thus, the second motor 40 can be reduced in size.

The bicycle driving device 30 includes the first motor 38 and the second motor 40. Thus, changes in the gear ratio r made by the second motor 40 can be separate from changes in the assist force made by the first motor 38. This allows for execution of a control that is further suitable for the riding conditions or the like.

The output shaft of the second motor 40 is coaxial with the first input body 48. This simplifies the structure of the bicycle driving device 30 compared to when the output shaft axis of the second motor 40 is separated from the axis of the first input body 48.

### Second Embodiment

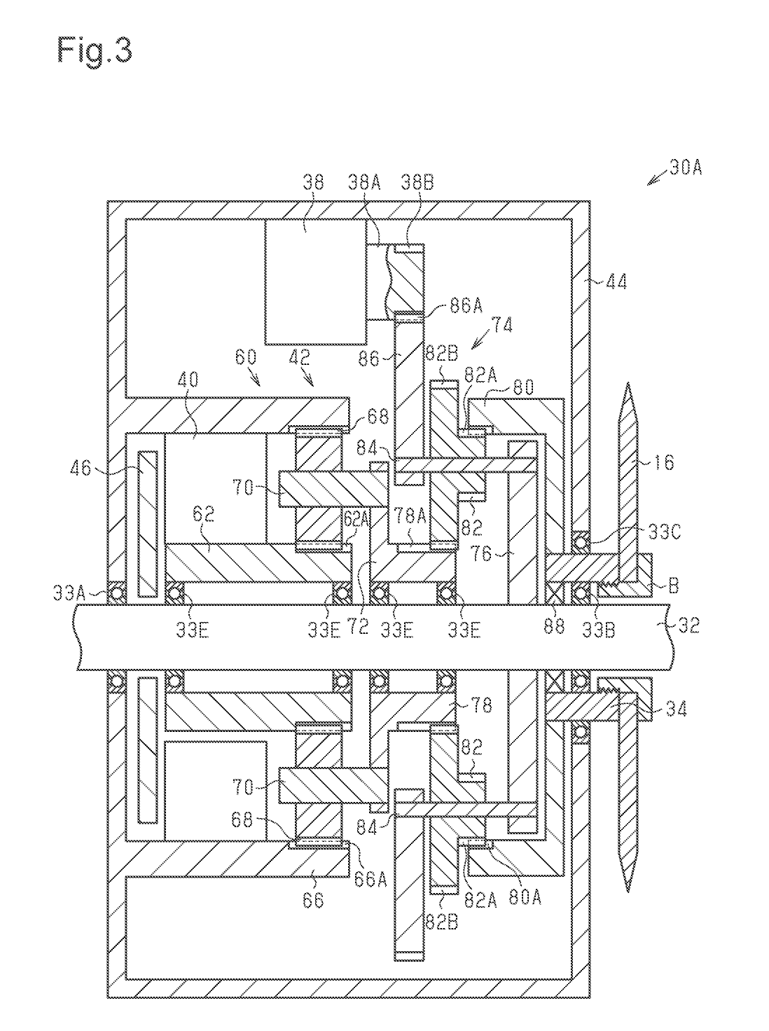

A bicycle driving device 30A of a second embodiment will now be described with reference to FIG. 3. Same reference characters are given to those components that are the same as the corresponding components of the first embodiment. Such components will not be described in detail.

In the present embodiment, the bicycle driving device 30A includes a first planetary mechanism 74, the first motor 38, the second motor 40 and the speed reduction mechanism 42. In one example, the bicycle driving device 30A further includes the crankshaft 32, the output part 34, the housing 44, the controller 46 and a switching mechanism 88.

The first planetary mechanism 74 is a planetary gear mechanism. The first planetary mechanism 74 includes a first input body 76, a first output body 80 and a first transmission body 78. The rotation of the crankshaft 32 is input to the first input body 76. The first transmission body 78 is an annular body.

The first input body 76 includes a plurality of first planetary gears 82, a plurality of first planetary pins 84 and a first carrier 86. Each of the first planetary gears 82 includes a first gear portion 82A and a second gear portion 82B. The first gear portion 82A differs from the second gear portion 82B in the number of teeth. The first gear portion 82A has fewer teeth than the second gear portion 82B. The first planetary gears 82 are each a stepped planetary gear. The teeth of the first gear portion 82A engage the teeth of a first ring gear 80A of the first output body 80. The teeth of the second gear portion 82B engage the teeth of a first sun gear 78A of the first transmission body 78. A first motor gear 86A is formed on the outer circumferential portion of the first carrier 86. The first motor gear 86A engages the gear 38B of the first motor 38.

The first transmission body 78 transmits the rotation of the first input body 76 to the first output body 80. The first transmission body 78 includes the first sun gear 78A.

The first output body 80 rotates when the first input body 76 rotates. The first output body 80 is an annular member. The first output body 80 includes the first ring gear 80A. The first ring gear 80A is formed on the inner circumferential portion of the first output body 80. The first output body 80 is coaxial with the output part 34 and fixed to the outer circumferential portion of the output part 34. The first output body 80 can be formed integrally with the output part 34.

The first motor 38 is capable of rotating the first input body 76. The gear 38B has fewer teeth than the first motor gear 86A. Thus, the rotation produced by the first motor 38 is reduced in speed and increased in torque when transmitted to the first input body 76.

The second motor 40 is supported by the housing 44. The output shaft of the second motor 40 is coaxial with the first input body 76. The second motor 40 is capable of rotating the first transmission body 78 with the speed reduction mechanism 42. More specifically, the rotation of the second carrier 72 of the speed reduction mechanism 42 is output to the first transmission body 78. The second carrier 72 is formed integrally with the first transmission body 78. In another example, the second carrier 72 is formed separately from the first transmission body 78 and coupled to the outer circumferential portion of the first transmission body 78 in a non-rotatable manner. The second carrier 72 rotates integrally with the first transmission body 78. The second carrier 72 and the second input body 62 are rotationally supported by bearings 33E on the crankshaft 32, not the output part 34.

The controller 46 controls the first motor 38 and the second motor 40. The controller 46 produces rotation with the second motor 40 to rotate the first transmission body 78 in the forward rotation direction. In this state, the gear ratio r of the first planetary mechanism 74 is larger than “1.”

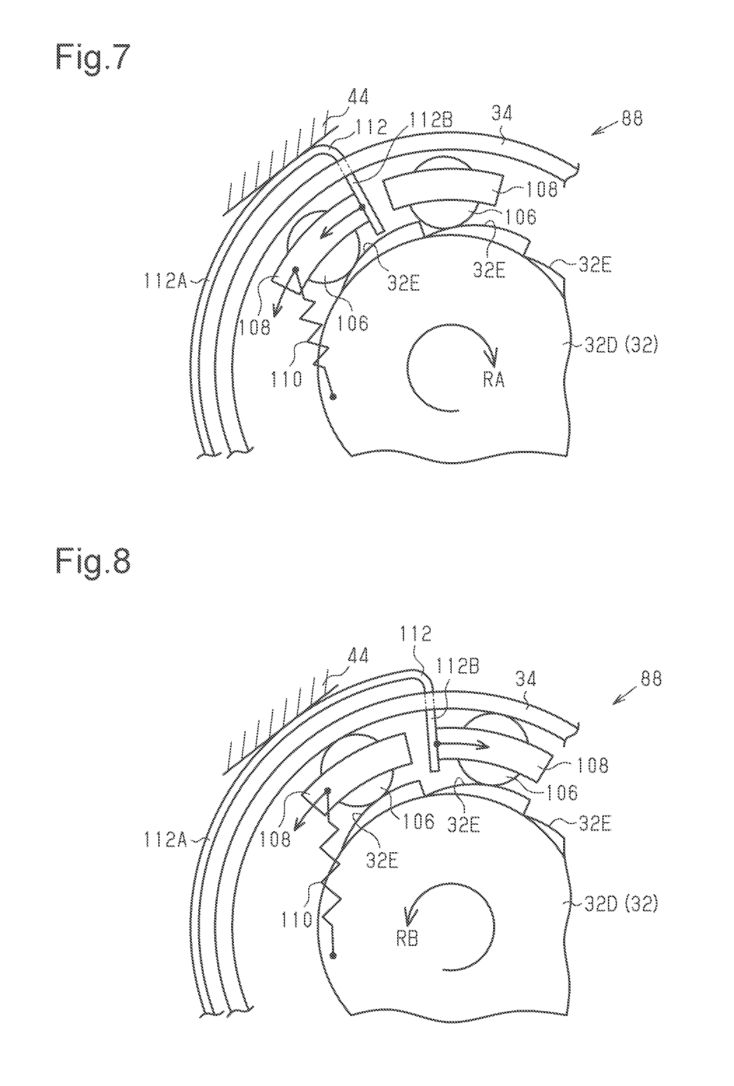

The switching mechanism 88 is located between the crankshaft 32 and the output part 34 or the first output body 80. The switching mechanism 88 can have the structure shown in FIGS. 7 and 8 and can be a typical roller clutch or pawl clutch. The switching mechanism 88 permits relative rotation of the crankshaft 32 and the output part 34 when the crankshaft 32 rotates in the first direction RA. The switching mechanism 88 integrally rotates the crankshaft 32 and the output part 34 when the crankshaft 32 rotates in the second direction RB. The coaster brake can be actuated by the switching mechanism 88 when the crankshaft 32 is rotated in the second direction RB. The second embodiment has the same advantages as the first embodiment.

### Third Embodiment

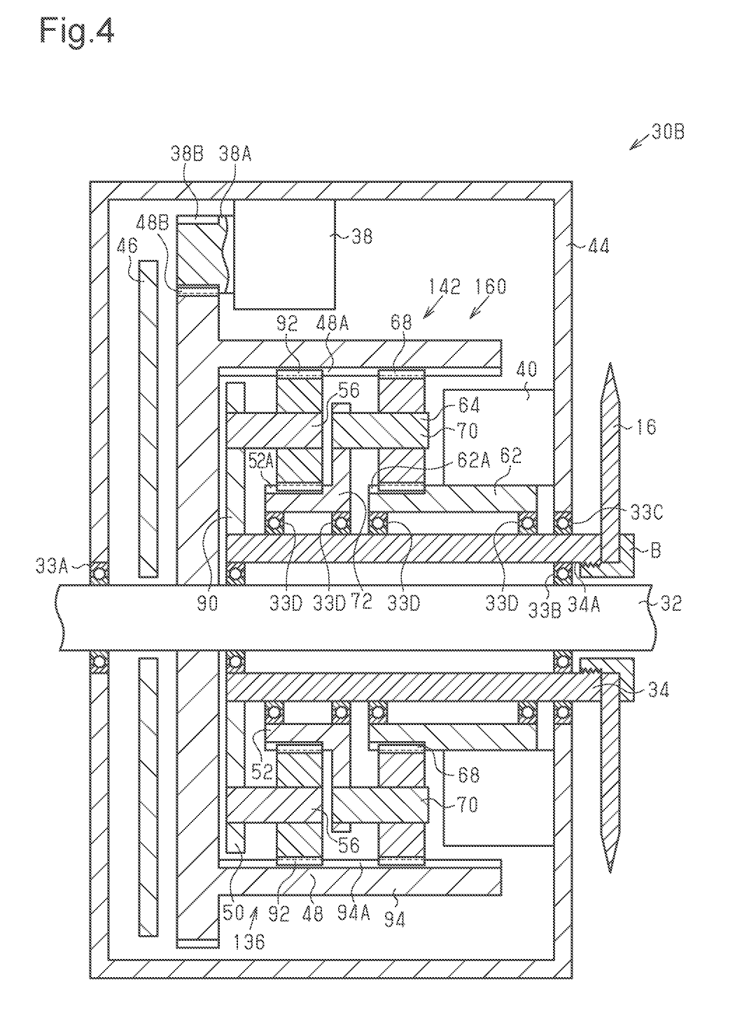

A bicycle driving device 30B of a third embodiment will now be described with reference to FIG. 4. Same reference characters are given to those components that are the same as the corresponding components of the first embodiment. Such components will not be described in detail.

In the present embodiment, the bicycle driving device 30B includes a first planetary mechanism 136, the first motor 38, the second motor 40 and a speed reduction mechanism 142. In one example, the bicycle driving device 30B further includes the crankshaft 32, the output part 34, the housing 44 and the controller 46.

The first planetary mechanism 136 includes the first input body 48, a first output body 90 and the first transmission body 52. The first output body 90 rotates when the first input body 48 rotates. The first output body 90 includes a plurality of first planetary gears 92, the first planetary pins 56 and the first carrier 58. Each of the first planetary gears 92 is located between the first sun gear 52A and the first ring gear 48A. The first planetary gears 92 engage the first ring gear 48A and the first sun gear 52A.

The speed reduction mechanism 142 includes a second planetary mechanism 160. The second planetary mechanism 160 includes the second input body 62, the second output body 64 and the second transmission body 94. The second transmission body 94 includes a second ring gear 94A. The second transmission body 94 is formed integrally with the first input body 48. The second ring gear 94A is formed integrally with the first ring gear 48A. The first input body 48 and the second transmission body 94 rotate integrally with each other. The second planetary gears 68 of the second output body 64 are supported by the first transmission body 52 and the second transmission body 94. Each of the second planetary gears 68 engages the second sun gear 62A and the second ring gear 94A. Each of the second planetary gears 68 has the same number of teeth as each of the first planetary gears 92.

In addition to the same advantages of the first embodiment, the third embodiment has the advantage described below.

The rotation of the first input body 48, which is rotated by the crankshaft 32, increases the speed reduction ratio of the second planetary mechanism 160 as compared to when the second transmission body 94 is supported in a non-rotatable manner relative to the housing 44. This allows for reduction in the torque applied to the output shaft of the second motor 40 by the crankshaft 32 and the first motor 38. Thus, the second motor 40 can be further reduced in size.

### Fourth Embodiment

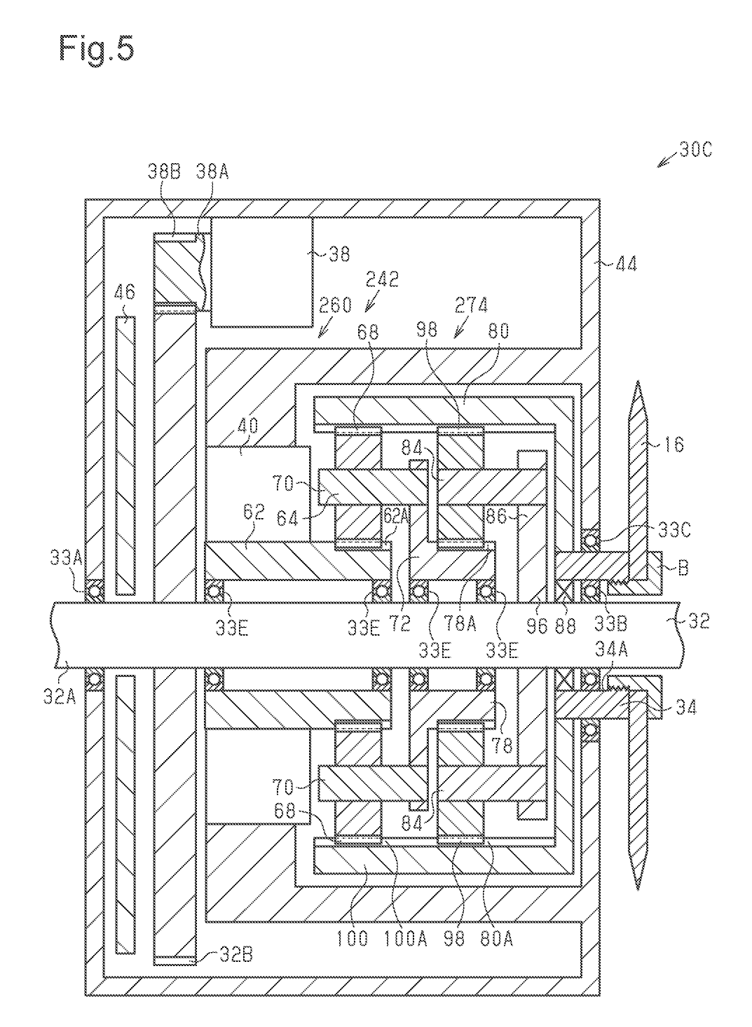

A bicycle driving device 30C of a fourth embodiment will now be described with reference to FIG. 5. Same reference characters are given to those components that are the same as the corresponding components of the second embodiment. Such components will not be described in detail.

In the present embodiment, the bicycle driving device 30C includes a first planetary mechanism 274, the first motor 38, the second motor 40 and a speed reduction mechanism 242. In one example, the bicycle driving device 30C further includes the crankshaft 32, the output part 34, the housing 44, the controller 46 and the switching mechanism 88.

The crankshaft 32 includes a crankshaft body 32A and a first motor gear 32B. The first motor gear 32B is an annular member. The first motor gear 32B is coaxial with the crankshaft body 32A and fixed to the outer circumference of the crankshaft body 32A. The output shaft 38A of the first motor 38 engages the first motor gear 32B. The first motor 38 is capable of rotating the crankshaft 32.

The first planetary mechanism 274 includes a first input body 96, the first output body 80 and the first transmission body 78. The first output body 80 rotates when the first input body 96 rotates. The first input body 96 includes first planetary gears 98, the first planetary pins 84 and the first carrier 86. The first carrier 86 is an annular member. Further, the first carrier 86 is coaxial with the crankshaft body 32A and fixed to the outer circumferential portion of the crankshaft body 32A. Each of the first planetary gears 98 is located between the first sun gear 78A and the first ring gear 80A. The first planetary gears 98 engage the first ring gear 80A and the first sun gear 78A.

The speed reduction mechanism 242 includes a second planetary mechanism 260. The second planetary mechanism 260 includes the second input body 62, the second output body 64 and a second transmission body 100. The second transmission body 100 includes a second ring gear 100A. The second transmission body 100 is formed integrally with the first output body 80. The second ring gear 100A is formed integrally with the first ring gear 80A. The first output body 80 and the second transmission body 100 rotate integrally with each other.

The second planetary gears 68 of the second output body 64 are supported by the first transmission body 78 and the second transmission body 100. Each of the second planetary gears 68 engages the second sun gear 62A and the second ring gear 100A. Each of the second planetary gears 68 has the same number of teeth as each of the first planetary gears 98. The fourth embodiment has the same advantages as the first to third embodiments.

### Fifth Embodiment

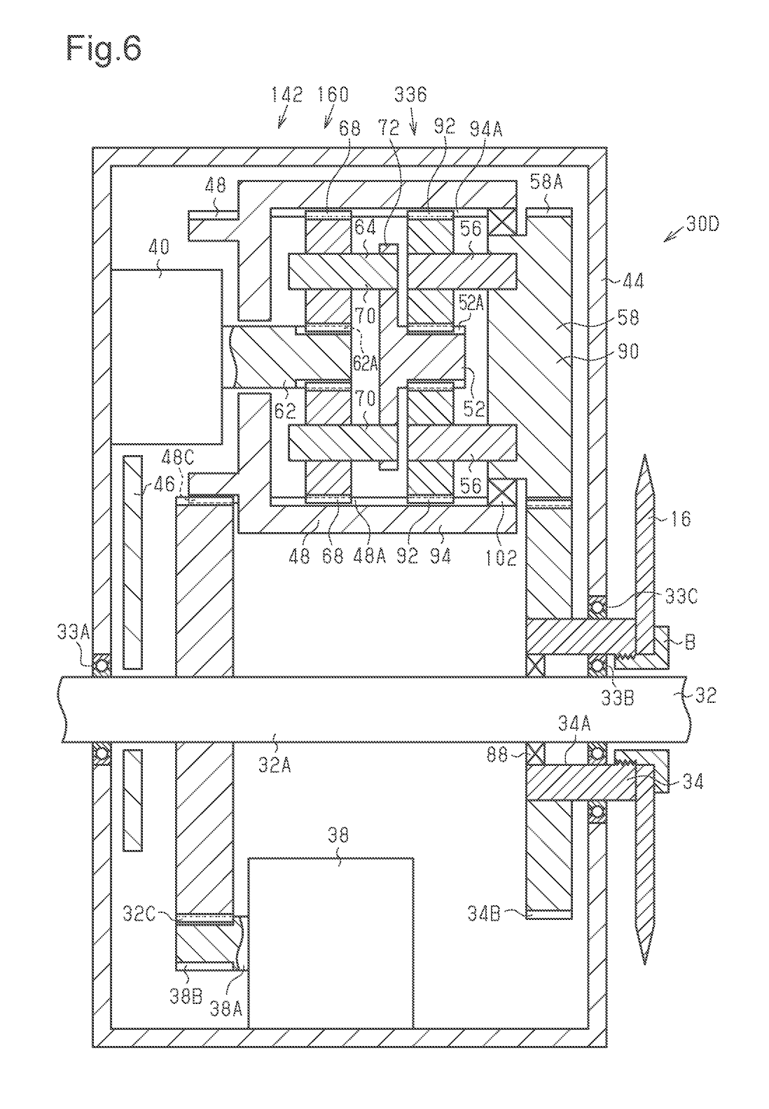

A bicycle driving device 30D of a fifth embodiment will now be described with reference to FIG. 6. Same reference characters are given to those components that are the same as the corresponding components of the third embodiment. Such components will not be described in detail.

In the present embodiment, the bicycle driving device 30D includes a first planetary mechanism 336, the first motor 38, the second motor 40 and the speed reduction mechanism 142. In one example, the bicycle driving device 30D further includes the crankshaft 32, the output part 34, the housing 44, the controller 46, a one-way clutch 102 and the switching mechanism 88.

The first planetary mechanism 336 is a planetary gear mechanism. The first planetary mechanism 336 includes the first input body 48, the first transmission body 52 and the first output body 90. The axis of the first planetary mechanism 336 is separated from the axis of the crankshaft 32. The axis of the first planetary mechanism 336 is parallel to the axis of the crankshaft 32. A portion of the crankshaft 32 is located toward the outer side from the outer circumferential portion of the first planetary mechanism 336 in the radial direction of the first planetary mechanism 336.

A second gear 48C is formed on the outer circumferential portion of the first ring gear 48A of the first input body 48. The second gear 48C engages a first gear 32C, which is formed on the outer circumferential portion of the crankshaft 32. The second gear 48C has fewer teeth than the first gear 32C. Thus, the rotation of the crankshaft 32 is increased in speed when input to the first planetary mechanism 336.

A third gear 58A is formed on the outer circumferential portion of the first carrier 58 of the first output body 90. The third gear 58A engages a fourth gear 34B, which is formed on the outer circumferential portion of the output part 34. The fourth gear 34B has more teeth than the third gear 58A. Thus, the rotation of the first planetary mechanism 336 is reduced in speed when input to the output part 34.

The first gear 32C differs from the fourth gear 34B in the number of teeth. It is preferred that the first gear 32C have more teeth than the fourth gear 34B. Further, it is preferred that the difference in the number of teeth be small between the first gear 32C and the fourth gear 34B.

The first motor 38 is arranged so that the axis of its output shaft 38A is parallel to the axis of the crankshaft 32. Further, the first motor 38 is arranged next to the crankshaft 32 at a position separated from the first planetary mechanism 336 in the circumferential direction of the crankshaft 32. The crankshaft 32 includes the crankshaft body 32A and the first gear 32C. The output shaft 38A of the first motor 38 engages the first gear 32C. The first motor 38 is capable of rotating the crankshaft 32.

The one-way clutch 102 is located between the first ring gear 48A and the first carrier 58. In one example, the one-way clutch 102 is formed by a roller clutch or a pawl clutch. The one-way clutch 102 does not transmit the rotation of the first ring gear 48A to the first carrier 58 when the crankshaft 32 rotates in the second direction RB. The one-way clutch 102 permits relative rotation of the first carrier 58 and the first ring gear 48A if the crankshaft 32 rotates in the first direction RA when the rotational speed of the first carrier 58 is greater than or equal to the rotational speed of the first ring gear 48A. The one-way clutch 102 rotates the first carrier 58 and the first ring gear 48A integrally with each other if the crankshaft 32 rotates in the first direction RA when the rotational speed of the first carrier 58 is less than or equal to the rotational speed of the first ring gear 48A.

The structure of the switching mechanism 88 will now be described with reference to FIGS. 6 to 8. FIGS. 7 and 8 are schematic views in which some of the members of the switching mechanism 88 are projected onto the same plane that is orthogonal to the crankshaft 32.

As shown in FIG. 6, at least a portion of the switching mechanism 88 is located between the crankshaft 32 and the output part 34. The switching mechanism 88 permits relative rotation of the crankshaft 32 and the output part 34 when the crankshaft 32 rotates in the first direction RA. The switching mechanism 88 rotates the crankshaft 32 and the output part 34 integrally with each other when the crankshaft 32 rotates in the second direction RB.

As shown in FIGS. 6 to 8, the switching mechanism 88 includes a plurality of rollers 106, a holder 108, a first biasing member 110, a second biasing member 112 and a plurality of grooves 32E. The grooves 32E are formed in the outer circumferential portion of the crankshaft 32. FIG. 7 shows only two rollers 106. However, it is preferred that there are three or more rollers 106 arranged at equal intervals in the circumferential direction of the crankshaft 32. The grooves 32E are formed in a support 32D that is arranged on the outer circumferential portion of the crankshaft 32. The depth of each of the grooves 32E increases in the second direction RB.

The rollers 106 are arranged on the outer circumferential portion of the support 32D. In detail, the rollers 106 are located between the outer circumferential portion of the crankshaft 32 and the inner circumferential portion of the output part 34. The rollers 106 are received in the grooves 32E, respectively. The support 32D of the crankshaft 32 can contact the rollers 106.

The holder 108 holds the rollers 106. The rollers 106 are held in a rotatable manner by the holder 108. The first biasing member 110 biases the rollers 106 with the holder 108 in the second direction RB. The second biasing member 112 is supported to be slidable on the housing 44. When the crankshaft 32 rotates in the second direction RB, the second biasing member 112 moves the rollers 106 with the holder 108 in the first direction RA relative to the crankshaft 32. The first biasing member 110 is formed by a spring such as a coil spring. The second biasing member 112 is formed by, for example, a slide spring. The second biasing member 112 includes an annular portion 112A and an end 112B that projects from the annular portion 112A toward the inner side in the radial direction. The annular portion 112A of the second biasing member 112 is supported by the housing 44 so as to be rotatable in the circumferential direction of the crankshaft 32. The end 112B of the second biasing member 112 can come into contact with holder 108.

The operation of the switching mechanism 88 will now be described.

When the crankshaft 32 shown in FIG. 6 is rotated in the first direction RA, the one-way clutch 102 maintains the gear radio r of the first planetary mechanism 336 at “1” or greater. Referring to FIG. 7, when the crankshaft 32 rotates in the first direction RA, the first biasing member 110 and the second biasing member 112 apply force with the holder 108 to the rollers 106 in the second direction RB. When the holder 108 rotates in the first direction RA as the crankshaft 32 rotates, the second biasing member 112 restricts movement of the rollers 106 relative to the crankshaft 32 in the first direction RA. Thus, the rollers 106 are located at deep positions in the grooves 32E. This separates the rollers 106 from the output part 34 and permits relative rotation of the crankshaft 32 and the output part 34.

Referring to FIG. 8, when the crankshaft 32 rotates in the second direction RB, the second biasing member 112 applies force with the holder 108 to the rollers 106 in the first direction RA and moves the rollers 106 relative to the crankshaft 32 in the first direction RA. When the force applied by the second biasing member 112 to the rollers 106 in the first direction RA becomes greater than the force applied by the first biasing member 110 to the rollers 106 in the second direction RB, the rollers 106 are located at shallow portions in the grooves 32E. Thus, the rollers 106 come into contact with both of the output part 34 and the outer circumferential portion of the crankshaft 32 and restrict relative rotation of the crankshaft 32 and the output part 34. This rotates the output part 34 and the crankshaft 32 integrally with each other.

In addition to the advantages of the first to third embodiments, the bicycle driving device 30D of the fifth embodiment has the advantages described below.

In the bicycle driving device 30D, the planetary mechanism 336 is located at the outer circumferential side of the crankshaft 32. This limits increases in the distance between the crankshaft 32 and the drive wheel.

The bicycle driving device 30D increases the speed of the rotation of the crankshaft 32 that is transmitted to the planetary mechanism 336. This reduces the torque input to the planetary mechanism 336. Thus, the second motor 40 can be reduced in size.

### Sixth Embodiment

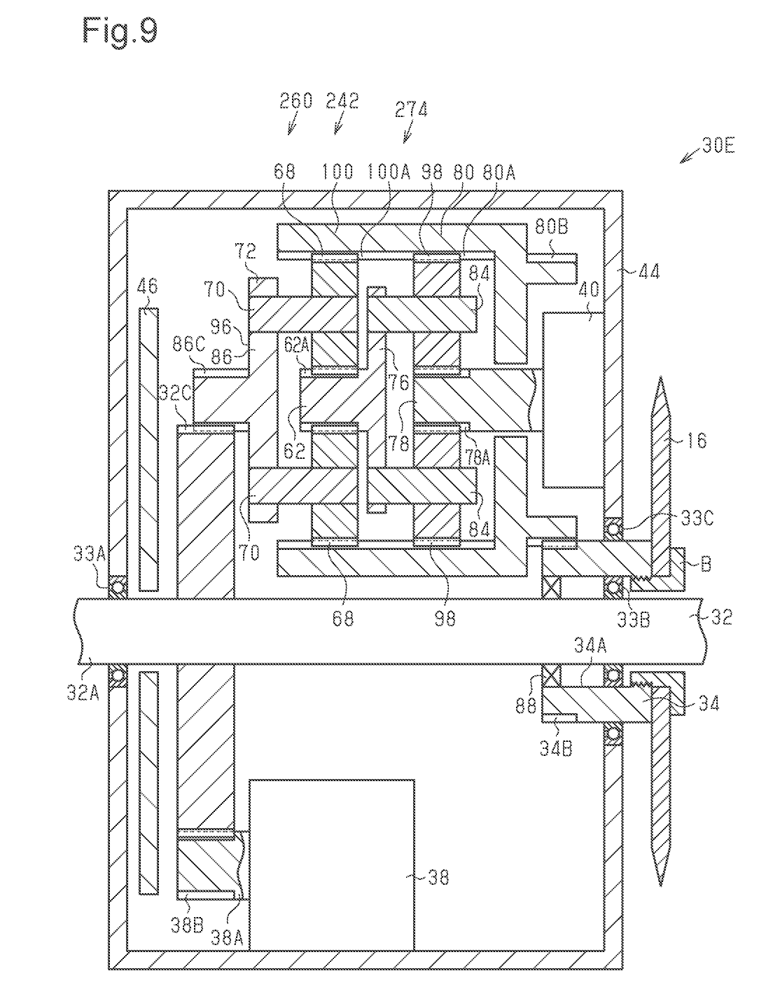

A bicycle driving device 30E of a sixth embodiment will now be described with reference to FIG. 9. Same reference characters are given to those components that are the same as the corresponding components of the fourth embodiment. Such components will not be described in detail.

In the present embodiment, the bicycle driving device 30E includes the first planetary mechanism 274, the first motor 38, the second motor 40 and a speed reduction mechanism 242. In one example, the bicycle driving device 30E further includes the crankshaft 32, the output part 34, the housing 44, the controller 46 and the switching mechanism 88.

The first motor 38 is arranged so that the axis of its output shaft 38A is parallel to the axis of the crankshaft 32. Further, the first motor 38 is arranged next to the crankshaft 32 at a position separated from the first planetary mechanism 274 in the circumferential direction of the crankshaft 32. The crankshaft 32 includes the crankshaft body 32A and the first gear 32C. The output shaft 38A of the first motor 38 engages the first gear 32C. The first motor 38 is capable of rotating the crankshaft 32.

A second gear 86C is formed on the outer circumferential portion of the first carrier 86 of the first input body 96. The second gear 86C engages the first gear 32C, which is formed on the outer circumferential portion of the crankshaft 32. The second gear 86C has fewer teeth than the first gear 32C. Thus, the rotation of the crankshaft 32 is increased in speed when input to the first planetary mechanism 274.

A third gear 80B is formed on the outer circumferential portion of the first ring gear 80A of the first output body 80. The third gear 80B engages the fourth gear 34B, which is formed on the outer circumferential portion of the output part 34. The fourth gear 34B has more teeth than the third gear 80B. Thus, the rotation of the crankshaft 32 is reduced in speed when input to output part 34.

The first motor 38 is arranged so that the axis of its output shaft 38A is parallel to the axis of the crankshaft 32. Further, the first motor 38 is arranged next to the crankshaft 32 at a position separated from the first planetary mechanism 274 in the circumferential direction of the crankshaft 32. The crankshaft 32 includes the crankshaft body 32A and the first gear 32C. The output shaft 38A of the first motor 38 engages the first gear 32C. The first motor 38 is capable of rotating the crankshaft 32. The sixth embodiment has the same advantages as the first, third and fifth embodiments.

### Modified Examples

The present disclosure is not limited to the foregoing embodiments and various changes and modifications of its components can be made without departing from the scope of the present disclosure. Also, the components disclosed in the embodiments can be assembled in any combination for embodying the present disclosure. For example, some of the components can be omitted from all components disclosed in the embodiments. Further, components in different embodiments can be appropriately combined.

The switching mechanism 88 of the second, fourth, fifth and sixth embodiments can include grooves in the inner circumferential portion of the output part 34 to receive the rollers 106. In any of the embodiments, a switching mechanism can be arranged between the crankshaft 32 and the output part 34 to permit relative rotation of the crankshaft 32 and the output part 34 when the crankshaft 32 rotates in the first direction RA and integrally rotate the crankshaft 32 and the output part 34 when the crankshaft 32 rotates in the second direction RB. Further, the switching mechanism 88 can be omitted from the second, fourth, fifth and sixth embodiments.

The bicycle driving devices 301) and 30E in the fifth and sixth embodiments can each further include a gear between the first gear 32C and the corresponding one of the second gears 48C and 86C to increase the speed of the rotation of the first gear 32C transmitted to the second gears 48C and 86C. Further, a belt or a chain running around the crankshaft 32 and the corresponding one of the first input bodies 48 and 76 can be used to increase the speed. Any speed-increasing mechanism can be used as long as the rotation of the crankshaft 32 can be increased in speed when transmitted to the first input bodies 48 and 76. In the fifth embodiment, the one-way clutch 102 can be omitted.

The bicycle driving devices 30D and 30E in the fifth and sixth embodiments can each further include a gear between the corresponding one of the third gears 58A and 80B and the fourth gear 34B to reduce the speed of the rotation of the third gears 58A and 80B that is transmitted to the fourth gear 34B. Further, a belt or a chain running around the output part 34 and the corresponding one of the first output bodies 50 and 80 can be used to reduce the speed. Any speed reduction mechanism can be used as long as the rotation of the first output bodies 50 and 80 can be reduced in speed when transmitted to the output part 34. A belt or a chain that runs between the first gear 32C and the corresponding one of the second gears 48C and 86C or between the corresponding one of the third gears 58A and 80B and the fourth gear 34B reverses the relationship of the direction in which the members of the planetary mechanisms 336 and 274 rotate and the direction in which the crankshaft 32 and the output part 34 rotate in the above embodiments. Thus, it is preferred that the structures of the one-way clutch 102 and the switching mechanism 88 be changed in accordance with the relationship in the rotation direction.

The speed reduction mechanisms 42, 142 and 242 of the above embodiments can each be changed to a speed reduction mechanism including gears that are engaged with each other. The gears are rotated relative to each other about parallel shafts, which are fixed to the housing 44. In this case, the torque of the second motor 40 can be increased when rotating the first transmission bodies 52 and 78. This allows the second motor 40 to be reduced in size.

The first motor 38 of each embodiment can be used to rotate the first output bodies 50 and 80. For example, a gear can be formed on the outer circumferential portion of each of the first output bodies 50 and 80 and engaged with the gear 38B of the output shaft 38A of the first motor 38.

The planetary mechanisms 36, 74, 136, 274 and 336 of the above embodiments can be planetary roller mechanisms. In this case, the sun gear is a sun roller, the planetary gear is a planetary roller, and the ring gear is a ring roller.

In the planetary mechanism of each of the above embodiments, as long as the input body, the output body, and the transmission body each includes one of following members (A) to (C) or as long as the input body, the output body, and the transmission body includes a combination of all of the following members (A) to (C), any of such structures can be employed. Member (A) is a sun gear. Member (B) is a ring gear. Member (C) is a planetary gear and a carrier.

In the above embodiments, each gear can be a spur gear or a helical gear. In the above embodiments, each gear can be formed from metal or plastic.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts unless otherwise stated.

As used herein, the following directional terms “frame facing side”, “non-frame facing side”, “forward”, “rearward”, “front”, “rear”, “up”, “down”, “above”, “below”, “upward”, “downward”, “top”, “bottom”, “side”, “vertical”, “horizontal”, “perpendicular” and “transverse” as well as any other similar directional terms refer to those directions of a bicycle in an upright, riding position and equipped with the bicycle driving device. Accordingly, these directional terms, as utilized to describe the bicycle driving device should be interpreted relative to a bicycle in an upright riding position on a horizontal surface and that is equipped with the bicycle driving device. The terms “left” and “right” are used to indicate the “right” when referencing from the right side as viewed from the rear of the bicycle, and the “left” when referencing from the left side as viewed from the rear of the bicycle.

Also it will be understood that although the terms “first” and “second” may be used herein to describe various components these components should not be limited by these terms. These terms are only used to distinguish one component from another. Thus, for example, a first component discussed above could be termed a second component and vice versa without departing from the teachings of the present invention. The term “attached” or “attaching”, as used herein, encompasses configurations in which an element is directly secured to another element by affixing the element directly to the other element; configurations in which the element is indirectly secured to the other element by affixing the element to the intermediate member(s) which in turn are affixed to the other element; and configurations in which one element is integral with another element, i.e. one element is essentially part of the other element. This definition also applies to words of similar meaning, for example, “joined”, “connected”, “coupled”, “mounted”, “bonded”, “fixed” and their derivatives. Finally, terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A bicycle driving device comprising:
a first planetary mechanism including a first input body to which rotation of a crank is inputted, a first output body that rotates when the first input body rotates, and a first transmission body that transmits rotation of the first input body to the first output body;
a first motor configured to rotate at least one of the first input body, the first output body, and the crank;
a second motor; and
a speed reduction mechanism is configured to reduce rotation produced by the second motor in speed and transmits the rotation to the first transmission body.

2. The bicycle driving device according to claim 1, wherein
the speed reduction mechanism includes a second planetary mechanism including a second input body to which rotation produced by the second motor is input, a second output body that rotates when the second input body rotates, and a second transmission body that transmits rotation of the second input body to the second output body.

3. The bicycle driving device according to claim 2, wherein
the second input body includes a second sun gear,
the second output body includes a second planetary gear and a second carrier, and the second transmission body includes a second ring gear.

4. The bicycle driving device according to claim 3, further comprising
a housing non-rotatably supporting the second ring gear.

5. The bicycle driving device according to claim 4, wherein
the first input body includes a first ring gear,
the first output body includes a first planetary gear and a first carrier,
the first transmission body includes a first sun gear,
the first planetary gear includes a first gear portion that engages the first ring gear and a second gear portion that engages the first sun gear, and
the first gear portion differs from the second gear portion in the number of teeth.

6. The bicycle driving device according to claim 4, wherein
the first output body includes a first ring gear,
the first input body includes a first planetary gear and a first carrier,
the first transmission body includes a first sun gear,
the first planetary gear includes a first gear portion that engages the first ring gear and a second gear portion that engages the first sun gear, and
the first gear portion differs from the second gear portion in the number of teeth.

7. The bicycle driving device according to claim 5, wherein
the first gear portion has fewer teeth than the second gear portion.

8. The bicycle driving device according to claim 3, wherein
the first input body includes a first ring gear,
the first output body includes a first planetary gear and a first carrier,
the first transmission body includes a first sun gear, and
the first input body and the second transmission body rotate integrally with each other.

9. The bicycle driving device according to claim 3, wherein
the first input body includes a first planetary gear and a first carrier,
the first output body includes a first ring gear,
the first transmission body includes a first sun gear, and
the first output body and the second transmission body rotate integrally with each other.

10. The bicycle driving device according to claim 5, wherein
the first sun gear has the same number of teeth as the second sun gear.

11. The bicycle driving device according to claim 5, wherein
the first ring gear has the same number of teeth as the second ring gear.

12. The bicycle driving device according to claim 2, wherein
the second planetary mechanism is coaxial with the first planetary mechanism.

13. The bicycle driving device according to claim 1, wherein
the crank includes a crankshaft, and
the first planetary mechanism is coaxial with the crankshaft and located at an outer side in a radial direction of the crankshaft.

14. The bicycle driving device according to claim 1, wherein
the crank includes a crankshaft, and
the crankshaft includes a portion located at an outer side in a radial direction of the first planetary mechanism from an outer circumferential portion of the first planetary mechanism.

15. The bicycle driving device according to claim 14, wherein
the first planetary mechanism has an axis that is parallel to an axis of the crankshaft,
the first motor includes an output shaft having an axis that is parallel to the axis of the crankshaft, and
the first motor is located next to the crankshaft at a position separated from the first planetary mechanism in a circumferential direction of the crankshaft.

16. The bicycle driving device according to claim 1, wherein
the second motor includes an output shaft that is coaxial with the first input body.
